(19) United States
(12) Patent Application Publication
(10) Pub. No.: US 2002/0067005 A1
(43) Pub. Date: Jun. 6, 2002

(54) Seal assembly

(76) Inventor: Allyn P. Bock, West Lafayette, IN (US)

Correspondence Address: MCGUIRE WOODS, ATTN: Andrew M. Calderon, 1750 Tysons Boulevard, Suite 1800, McLean, VA, 22102-4215, US

(21) Appl. No.: 09/729,759

(22) Filed: Dec. 5, 2000

(51) Int. Cl. F02F 11/00

(52) U.S. Cl. 277/591

(57) ABSTRACT

A seal assembly having a protective layer for preventing damage to the seal assembly during the assembly of an internal combustion engine. The seal assembly provides a robust seal between components of the internal combustion engine thereby ensuring the optimal performance of the internal combustion engine. The seal assembly has a sealing layer and a protective shield layer made from a resilient material. The resilient material of the protective shield layer prevents damage to the sealing layer during an assembly of components of the internal combustion engine.

### TECHNICAL FIELD

This invention relates generally to a seal assembly and, more particularly, to a seal assembly having a protective shield layer.

### BACKGROUND ART

Internal combustion engines include a multitude of components which must be mounted to one another or to an engine block of the internal combustion engine. The proper mounting of these components is of the utmost importance since such proper mounting will ensure that the internal combustion engine is performing at an optimal and peak level of performance. These components may include, for example, after coolers, intake manifolds and the like.

Seal assemblies are provided between the components in order to ensure that the components are properly mounted to one another or to the engine block. These seal assemblies typically consist of a rubber gasket which is positioned within a sealing groove of one of the components or the engine block so as to safeguard against leakage of air and fluids such as coolant, oil and the like. However, it is currently known that many components of the internal combustion engine include sharp edges which are not adequately milled or chamfered. These sharp edges, in turn, damage (e.g., cut) the seal assembly during the assembly of the internal combustion engine. In these cases, the seal assembly is provided to the detriment of the performance of the internal combustion engine and must be removed and replaced at great expense to the manufacturer of the internal combustion engine. As an alternative to replacing the seal assembly, the components of the internal combustion engine may be milled to such exacting standards and tolerance so as not to contribute to the cutting of the seal assembly. However, such exacting standards and tolerances come at great expense and, in many instance, are not practically achievable by the manufacturer of such components.

U.S. Pat. No. 5,383,439 to Bock issued on Jan. 24, 1995 discloses an air inlet after cooler mounting and sealing system for use with an internal combustion engine. A compressible U-shaped seal is provided between the intake of the after cooler and the intake manifold and between the outlet of the after cooler and a distribution manifold to seal against leakage of charged intake air from the manifold joints. The clamp load across the compressible seals is independent of the clamp load across the manifolds to enhance seal life and reduce the number of fasteners required to assemble the after cooler between the intake manifold and the distribution manifold.

The present invention is directed to overcoming one or more of the problems as set forth above.

### DISCLOSURE OF THE INVENTION

In one aspect of the present invention a seal assembly is provided. The seal assembly has a sealing layer and a protective shield layer made from a resilient material. The resilient material of the protective shield layer prevents damage to the sealing layer during an assembly of components of an internal combustion engine.

In another aspect of the present invention an internal combustion engine has an engine block and first and second components. A seal assembly is positioned between the first component and the second component. The seal assembly has a sealing layer and a protective shield layer made from a resilient material. The protective shield layer prevents damage to the sealing layer during assembly of the internal combustion engine.

### BRIEF DESCRIPTION OF THE DRAWINGS

FIG. 1 shows a diagrammatic perspective view of the seal assembly of the present invention;

FIG. 2 shows a diagrammatic side plan view of the seal assembly;

FIG. 3 shows a diagrammatic side plan view of an alternative embodiment of the seal assembly;

FIG. 4 shows a cross sectional view of the seal assembly along line 3-3 of FIG. 1; and

FIG. 5 shows a side plan view of an internal combustion engine adapted for use with the seal assembly of the present invention.

### BEST MODE FOR CARRYING OUT THE INVENTION

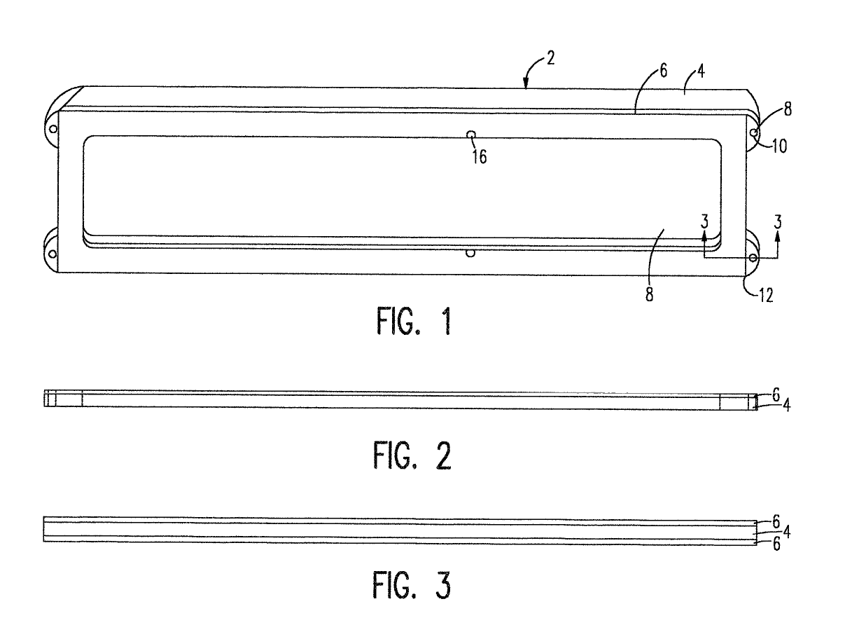

FIG. 1 shows a seal assembly of the present invention generally depicted as reference numeral 2. The seal assembly 2 is a composite seal assembly which includes a first layer 4 and a second protective shield layer 6. The first layer 4 is preferably molded rubber, silicone or other compressible flexible elastomer material such as, for example, a highly saturated nitrile rubber (HSN) or a fluorocarbon such as a vinylidene fluoride-hexafluoropropylene copolymer. The protective shield layer 6, attached to a surface of the first layer 4, is preferably Teflon® (Polytetraflouroethylenes (PTFE))but may be selected from the class of Polyamide Imides or Polyether Etherketones (PEEK) or other similar material having resilient properties.

Still referring to FIG. 1, the seal assembly 2 preferably has a rectangular shape, but may be other shapes such as circular, oval or other shapes conforming to a sealing groove. The seal assembly 2 also includes a “punched out” hollow interior portion 8. At least one tab 10 and more preferably four tabs 10 extend from the seal assembly 2 and more specifically the protective shield layer 6 portion of the seal assembly 2. The four tabs 10 may extend respectively from each corner 12 of the seal assembly 2. Apertures 14 are provided in each of the tabs 10. Further apertures 14a may also be located throughout the body of the seal assembly 2 and more specifically from the protective shield layer 6 portion of the seal assembly 2. The material of the first layer (hereinafter referred to as “rubber seal”) 4 is preferably molded or extruded through the apertures 14 and 14a of the protective shield layer to form the composite structure; however, the rubber seal 4 may be retained to the protective shield layer 6 by screws, adhesives, tapes or the like.

FIG. 2 shows a side view of the seal assembly 2. In FIG. 2, the protective shield layer 6 is positioned on a top surface of the rubber seal 4. The protective shield layer 6 may also be positioned on a bottom surface of the rubber seal 4 as well as on both surfaces of the rubber seal 4. In these embodiments, the protective shield layer 6 would be formed and attached to the rubber seal 4 in the same manner as discussed in detail with reference to FIG. 1.

FIG. 2 also shows a flat cross section in the horizontal plane for both the rubber shield 4 and the protective shield layer 6. The protective shield layer 6 is prepared from an approximate 0.8 mm thick flat die stamped sheet of preferably Teflon® (Polytetraflouroethylene (PTFE)). It should be recognized by those of ordinary skill in the art, however, that the protective shield layer 6 and the rubber seal 4 may also be, for example, oval or other cross sections conforming to a cross sectional shape of the seal groove. The protective shield layer 6 may also be other dimensions such as greater than 0.8 mm depending on the particular application of the present invention.

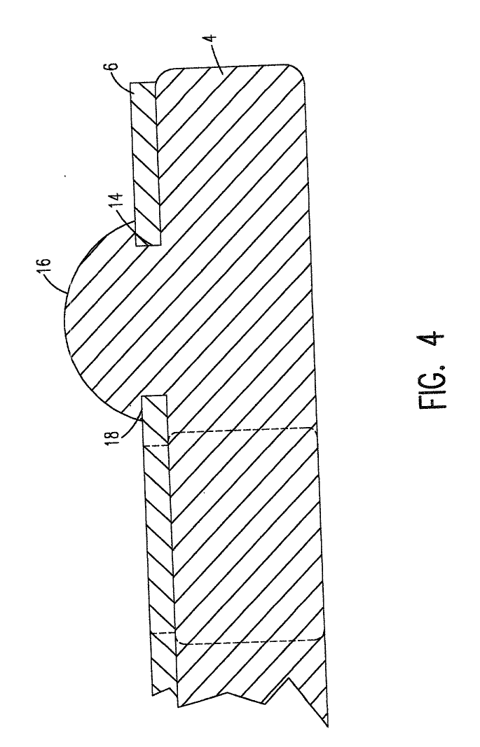

FIG. 3 shows a diagrammatic side plan view of an alternative embodiment of the seal assembly. In FIG. 3, the protective shield layer 6 is positioned on opposing sides of the rubber seal 4.

FIG. 4 shows a cross sectional view of the seal assembly 2 along line 3-3 of FIG. 1. As shown in FIG. 4, the rubber seal 4 is molded (or extruded) through the apertures 14 to form a protuberance or flange 16. A lip 18 of the flange 16 overlaps edges of the aperture 14 so as to rest on a surface of the protective shield layer 6.

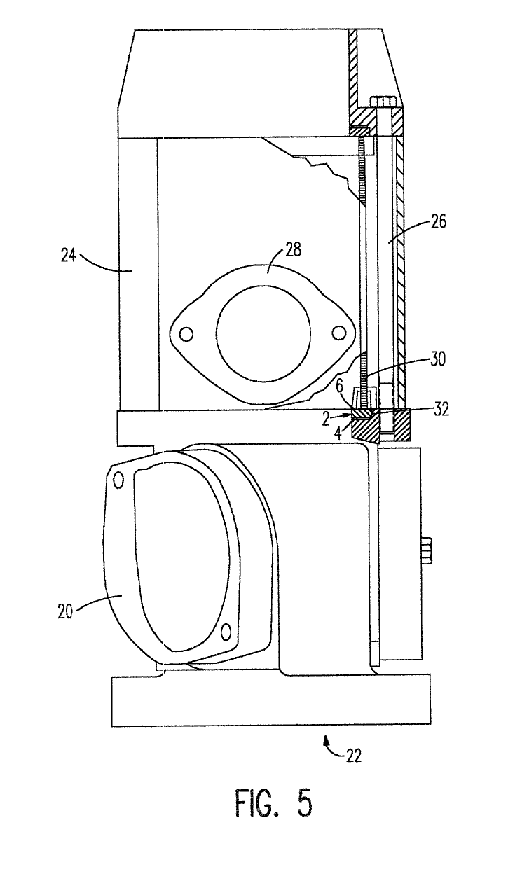

FIG. 5 shows a side plan view of an internal combustion engine adapted for use with the seal assembly 2. In particular, an air inlet manifold 20 is mounted to an engine block 22. An after cooler 24 is mounted to the air inlet manifold 20 via bolts 26. The after cooler 24 includes a water connection 28 and an outer side wall 30 having a generally rectangular-shape corresponding to a sealing groove 32 of the air inlet manifold 20 for mounting therein. The seal assembly 2 is positioned within the sealing groove 32 and between an end of the outer side wall 30 and the air inlet manifold 20. The protective shield layer 6 is in contact with the end of the outer side wall 30 of the after cooler 24 and the rubber seal 4 is in contact with the air inlet manifold 20 within the sealing groove 30.

It is noted that when the protective shield layer 6 is provided on both sides of the rubber seal 4, the protective shield 6 will contact both the air inlet manifold 20 and the outer side wall 30 while portions of the rubber seal 4 will remain in contact with the air inlet manifold 20. The seal assembly 2 may equally be positioned within any seal groove between components of the internal combustion engine.

Industrial Applicability

In operation, the after cooler 24 cools heated charged air provided by a compressor prior to entry into the combustion cylinders to increase the power output and performance of the internal combustion engine. Any leakage of the charged intake air prior to combustion represents a loss of performance and efficiency for the internal combustion engine. The seal assembly 2 and more specifically the protective shield layer 6 prevents any leakage thereof by ensuring that: the rubber seal 4 is not damaged during the assembly of the after cooler 24 to the air inlet manifold 20. The seal assembly 2 thus provides a structurally robust mounting arrangement.

The seal assembly 2 is also designed to accommodate differing thermal growth rates between the various components of the internal combustion engine. Thus, for example, the after cooler 24 as well as other components of the internal combustion engine can be constructed of various types of material without affecting the sealing performance of the seal assembly 2.

Being more specific, the seal assembly 2 is placed within the sealing groove 32 of the air inlet manifold 20. The protective shield layer 6 faces upward away from the air inlet manifold 20 while the rubber seal 4 faces toward the air inlet manifold 20 within the sealing groove 32. A double sided tape may be used to secure the seal assembly 2 to the sealing groove 32 or alternatively, the outer side wall 28 during the assembly process.

The after cooler 24 is mounted on the air inlet manifold 20 by placing an end of the side wall 30 on the protective shield layer 6 of the seal assembly 2. The bolts 26 are then tightened to a predetermined torque in order to seal the after cooler 24 to the air inlet manifold 20.

During the sealing assembly, the seal assembly 2 is deflected downward toward an inner portion of the sealing groove 32. In this manner, the rubber seal 4 is compressed to provide a robust seal between the outer side wall 30 of the after cooler 24 and the air inlet manifold 20. The protective shield layer 6, on the other hand, contacts the outer side wall 30 of the after cooler 24 and provides protection for the rubber seal 4 from being cut or otherwise damaged by the ends of the outer side wall 30 during the assembly process. The protective shield layer thus distributes isolated loading forces applied to the protective shield layer 6 across the sealing layer 4.

The seal assembly 2 may equally have the protective shield layer 6 on both sides thereof. During the assembly process of this embodiment of the seal assembly 2, the protective shield 6 will contact both the air inlet manifold 20 and the outer side wall 30 while portions of the rubber seal 4 remain in contact with the air inlet manifold 20 within the sealing groove 32. The rubber seal 4 provides a robust seal between the air inlet manifold 30 and the after cooler 24.

The seal assembly 2 may also be used between other components of the internal combustion engine in order to provide a robust seal between the rubber seal 4 and the component. For example, the seal assembly 2 may be used between the air inlet manifold 20 and the engine block 22.

Other aspects, objects and advantages of this invention can be obtained from a study of the drawings, the disclosure and the appended claims.

1. A seal assembly, comprising:
a sealing layer having a first side and a second side; and
a protective shield layer connected to the first side of the sealing layer,
the protective shield layer being made from a resilient material and being positioned to distribute isolated loading forces applied to the protective shield layer across the first side of the sealing layer.

2. The seal assembly of claim 1, wherein the sealing layer is one of a molded rubber, a silicone, and a flexible elastomer material.

3. The seal assembly of claim 2, wherein the flexible elastomer material is a highly saturated nitrile rubber (HSN) or a vinylidene fluoride-hexafluoropropylene copolymer.

4. The seal assembly of claim 1, wherein the protective shield layer is selected from a group consisting of Polyamide Imides, Polyether Etherketones (PEEK) and Polytetraflouroethylenes (PTFE).

5. The seal assembly of claim 1, including at least one tab on the protective shield layer.

6. The seal assembly of claim 5, wherein the at least one tab is four tabs, each of the four tabs being located on respective corners of the protective shield layer.

7. The seal assembly of claim 5, including apertures located within the at least one tab, the sealing layer having portions molded through the apertures to form a flange for retaining the protective shield layer to the sealing layer.

8. The seal assembly of claim 7, including:
a second protective shield layer attached to the second side of the sealing layer;
at least one tab extending from the second protective shield layer;
apertures located within the at least one tab of the second protective shield, the sealing layer having further portions molded through the apertures of the second protective shield layer to form further flanges for retaining the second protective shield layer to the sealing layer.

9. The seal assembly of claim 1, including at least one aperture in the protective shield layer, the sealing layer having portions molded through the at least one aperture to form a flange for retaining the protective shield layer to the sealing layer.

10. The seal assembly of claim 1, including adhesive, tape or screws attached between the protective shield layer and the sealing layer for retaining the protective shield layer to the sealing layer.

11. The seal assembly of claim 1, wherein the sealing layer and the protective shield layer have a flat cross section in a horizontal plane.

12. The seal assembly of claim 1, wherein the protective shield layer is approximately 0.8 mm in thickness.

13. A composite seal assembly, comprising:
a sealing layer having an interior portion and a flat cross section; and
a protective shield layer made from a resilient material attached to the sealing layer and having a flat cross section;
at least one tab extending from the protective shield layer;
an aperture located within each of the at least one tab;
a flange extending from the sealing layer and through the aperture; and
a lip extending outward from the flange and in engagement with a surface of the protective shield layer, said lip removably connecting the protective shield layer to the sealing layer.

14. The composite seal assembly of claim 13, wherein the sealing layer is one of a molded rubber, a silicone, and a flexible elastomer material.

15. The composite seal assembly of claim 13, wherein the protective shield layer is selected from the group consisting of Polyamide Imides, Polyether Etherketones (PEEK) and Polytetraflouroethylenes (PTFE).

16. The composite seal assembly of claim 13, wherein the at least one tab is four tabs located on respective corners of the protective shield layer.

17. An internal combustion engine, comprising:
an engine block;
a first component having a sealing groove on a first side, the first component being mounted to the engine block on a second side;
a second component mounted within the sealing groove of the first component;
a seal assembly positioned within the sealing groove and between the first component and the second component, the seal assembly including a sealing layer and a protective shield layer made from a resilient material attached to the sealing layer, the protective shield layer contacting the second component and the sealing layer contacting the first component within the sealing groove to form a seal between the first component and the second component,
wherein the resilient material of the protective shield layer prevents damage to the sealing layer caused by the second component during assembly of the internal combustion engine.

18. The internal combustion engine of claim 17, wherein the first component is an air inlet manifold and the second component is an after cooler.

19. The internal combustion engine of claim 18, wherein the second component includes an outer side wall which is positioned within the sealing groove of the air inlet manifold, the protective shield layer preventing damage to the sealing layer of the seal assembly caused by the outer side wall being placed within the sealing groove during the assembly of the internal combustion engine.

20. The internal combustion engine of claim 19, wherein the seal assembly includes a second protective shield layer on an opposing side of the sealing layer, the second protective shield layer contacting the air inlet manifold and sides of the sealing layer also contacting the air inlet manifold within the sealing groove.

21. A method of assembling a seal, comprising the steps of:
providing a sealing layer having a first side and a second side;
connecting a first protective layer to the first side of the sealing layer, the first protective layer distributing isolated loading forces applied to the protective shield layer across the first side of the sealing layer and further preventing damage to the sealing layer during an assembly of components of an internal combustion engine.

22. The method of assembling a seal of claim 21, including the steps of connecting a second protective layer to the second side of the sealing layer.

23. The method of assembling a seal of claim 21, including providing at least one tab extending from the first protective layer.
